(19) United States
(12) Patent Application Publication
(10) Pub. No.: US 2012/0060387 A1
(43) Pub. Date: Mar. 15, 2012

(54) HEAT EXCHANGER FOR A HEAT PUMP LAUNDRY DRYER

(75) Inventor: Wei-Wen Wang, Louisville, KY (US)

(73) Assignee: GENERAL ELECTRIC COMPANY, Schenectady, NY (US)

(21) Appl. No.: 13/097,616

(22) Filed: Apr. 29, 2011

(51) Int. Cl. F26B 19/00; F26B 25/16

(52) U.S. Cl. 34/86

(57) ABSTRACT

A heat pump laundry dryer and, more particularly, a heat exchanger that can provide improved efficiency for a heat pump laundry dryer is described. A refrigerant based heating system is used for both heating air to be supplied to a drum containing the articles and for cooling air from the drum so as to condense moisture contained therein. Heat exchange between the suction line supplying refrigerant to a compressor and an outlet line from a gas cooler is provided for improved thermal efficiency.

### FIELD OF THE INVENTION

The present invention relates to a heat pump laundry dryer and, more particularly, to a heat exchanger that can provide improve efficiency for a heat pump laundry dryer.

### BACKGROUND OF THE INVENTION

A conventional appliance for drying articles such as a clothes dryer (or laundry dryer) for drying clothing articles typically includes a cabinet including a rotating drum for tumbling clothes and laundry articles therein. One or more heating elements heats air prior to air entering the drum, and the warm air is circulated through the drum as the clothes are tumbled to remove moisture from laundry articles in the drum. A gas or electric heater may be used to heat air that is circulated through the drum.

In a known operation, ambient air from outside is drawn into the cabinet and passed through the heater before being fed to the drum. Moisture from the clothing is transferred to the air passing through the drum. Typically, this moisture laden air is then transported away from the dryer by e.g., a duct leading outside of the structure or room where the dryer is placed. The exhausted air removes moisture from the dryer and the clothes are dried as the process is continued by drawing in more ambient air.

Unfortunately, for the conventional dryer described above, the exhausted air is still relatively warm while the ambient air drawn into the dryer must be heated. This process is relatively inefficient because heat energy in the exhausted air is lost and additional energy must be provided to heat more ambient air. More specifically, the ambient air drawn into the dryer is heated to promote the liberation of the moisture out of the laundry. This air, containing moisture from the laundry, is then exhausted into the environment along with much of the heat energy that was used to raise its temperature from ambient conditions.

One alternative to a conventional dryer as described above is a heat pump dryer. More specifically, a heat pump dryer uses a refrigerant cycle to both provide hot air to the dryer and to condense water vapor in air coming from the dryer. Because the moisture content in the air from the dryer is reduced by the condensation over the evaporator, this same air can be reheated again and passed through the dryer to remove more moisture. Because the air is recycled through the dryer in a closed loop rather than being ejected to the environment, the heat pump dryer can be more efficient to operate than the traditional dryer described above. In addition, the heating source provided by the sealed refrigerant system of a heat pump dryer can be more efficient than a gas or electric heater implemented in the conventional dryer.

However, energy is required operate the refrigerant cycle for a heat pump dryer and there are opportunities for improving efficiency. In addition, the equipment for operating such a cycle can be relatively expensive. One such piece of the equipment is the compressor, which is used to pressurize the refrigerant gas as part of the refrigerant cycle. The compressor can be damaged if e.g., liquid refrigerant rather than gaseous refrigerant is fed into the compressor.

Accordingly, a clothes dryer that can provide for improved energy efficiency would be useful. More particularly, a clothes dryer that can provide for efficiency in the operation of a heat pump system used to remove moisture from the clothes and other articles would be beneficial. Such a system that can also be used to preclude the entry of liquid refrigerant into the compressor would also be very useful.

### BRIEF DESCRIPTION OF THE INVENTION

Aspects and advantages of the invention will be set forth in part in the following description, or may be obvious from the description, or may be learned through practice of the invention.

In one exemplary embodiment, a laundry dryer is provided that includes a drum for receipt of a load of articles for drying, a heater for raising the temperature of air supplied to the drum; and, a refrigerant based heating system. The refrigerant based heating system includes a compressor for pressurizing a refrigerant; a gas cooler for cooling refrigerant from the compressor and heating air provided to the drum or the heater; an evaporator for vaporizing refrigerant and cooling and dehumidifying air from the drum; and, a heat exchanger for transferring heat between refrigerant flowing from the gas cooler and refrigerant flowing from the evaporator.

In another exemplary embodiment, the present invention provides a laundry dryer that includes a drum for the receipt of articles for drying; a fan for circulating air for drying articles in the drum; and, a system for the treatment of the air circulated by the fan. The system includes a compressor for pressurizing a refrigerant; a gas cooler for exchanging heat between the refrigerant and the air circulated by the fan so as to increase the temperature of air fed to the drum; and an evaporator for exchanging heat between the refrigerant and the air circulated by the fan so as decrease the temperature and moisture content of air fed from the drum. A heat exchanger is provided for cooling refrigerant from the gas cooler with refrigerant from the evaporator.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an exemplary embodiment of a clothes dryer of the present invention.

FIG. 2 provides another perspective view, with a portion of the cabinet removed, of the clothes dryer of FIG. 1.

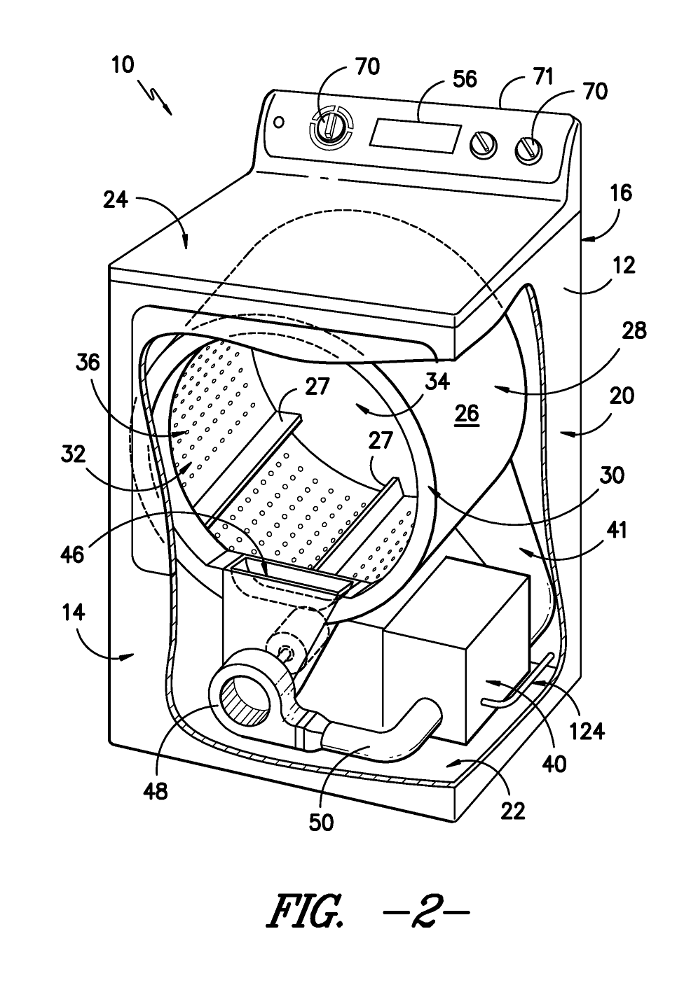

FIG. 3 provides a schematic view of a heat pump cycle and associated air flow according to an exemplary aspect of the present invention.

### DETAILED DESCRIPTION OF THE INVENTION

The present invention relates to a heat pump laundry dryer and, more particularly, to a heat exchanger that can provide improved efficiency for a heat pump laundry dryer. A refrigerant based heating system is used for both heating air to be supplied to a drum containing the articles and for cooling air from the drum so as to condense moisture contained therein. A heat exchange between the suction line supplying refrigerant to a compressor and an outlet line from a gas cooler is provided for improved efficiency.

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “article” may refer to but need not be limited to fabrics, textiles, garments (or clothing), and linens. Furthermore, the term “load” or “laundry load” refers to the combination of articles that may be washed together in a washing machine or dried together in a laundry dryer (i.e. clothes dryer) and may include a mixture of different or similar articles of different or similar types and kinds of fabrics, textiles, garments and linens within a particular laundering process.

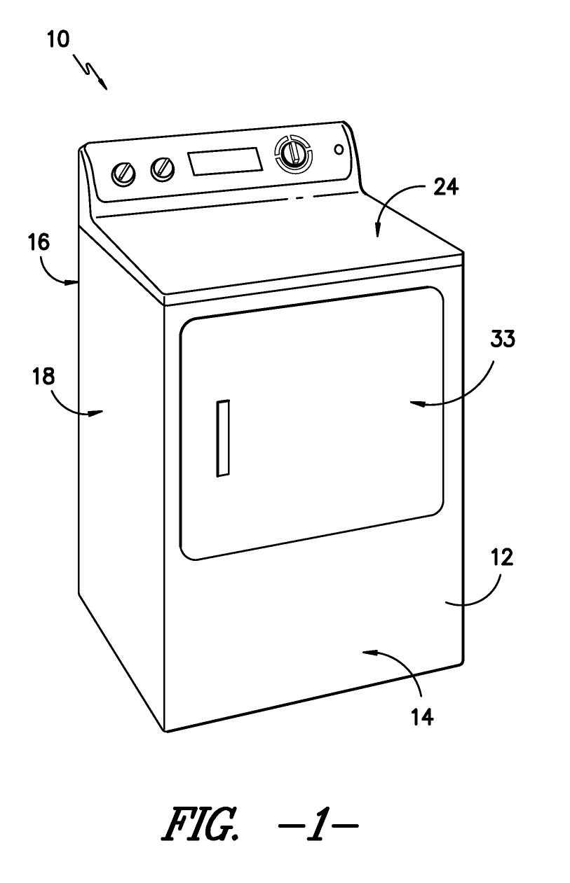

FIG. 1 illustrates an exemplary embodiment of a clothes dryer appliance 10 of the present invention. While described in the context of a specific embodiment of clothes dryer 10, using the teachings disclosed herein it will be understood that dryer 10 is provided by way of example only. Other clothes dryers have a different appearance and different features may also be utilized with the present invention as well.

Clothes dryer 10 includes a cabinet or a main housing 12 having a front panel 14, a rear panel 16, a pair of side panels 18 and 20 spaced apart from each other by front and rear panels 14 and 16, a bottom panel 22, and a top cover 24. Within cabinet 12 is a drum or container 26 mounted for rotation around a substantially horizontal axis. A motor (not shown) rotates the drum 26 about the horizontal axis through a pulley and a belt (not shown). The drum 26 is generally cylindrical in shape, having an imperforate outer cylindrical wall 28 and a front flange or wall 30 defining an opening 32 of drum 26 for loading and unloading of clothing articles and other fabrics. Outer cylindrical wall 28 could also be perforated as well in other embodiments of the invention.

A plurality of tumbling ribs 27 are provided within drum 26 to lift clothing articles therein and then allow them to tumble back to a bottom of drum 26 as drum 26 rotates. Drum 26 includes a rear wall 34 rotatably supported within main housing 12 by a suitable fixed bearing. Rear wall 43 can be fixed or can be rotatable. Rear wall 34 includes a plurality of holes 36 that receive hot air that has been heated by a heating system 40 to be described further below. Moisture laden, heated air is drawn from drum 26 by a blower fan 48. The air passes through a screen filter 46 which traps lint particles. As the air passes from blower fan 48, it enters a duct 50 and then is passed into heating system 40. Heated air (with a lower moisture content than was received from drum 26), exits heating system 40 and returns to drum 26 by duct 41. After the clothing articles have been dried, they are removed from the drum 26 via opening 32. A door 33 provides for closing or accessing drum 26 through opening 32.

A cycle selector knob 70 is mounted on a cabinet backsplash 71 and is in communication with a processing device or controller 56. Signals generated in controller 56 operate the drum drive system and heating elements in response to the position of selector knobs 70. Alternatively, a touch screen type interface may be provided. As used herein, “processing device” or “controller” may refer to one or more microprocessors or semiconductor devices and is not restricted necessarily to a single element. The processing device can be programmed to operate drying machine 10 according to the exemplary aspects of the present invention as set forth below. The processing device may include, or be associated with, one or memory elements such as e.g., electrically erasable, programmable read only memory (EEPROM).

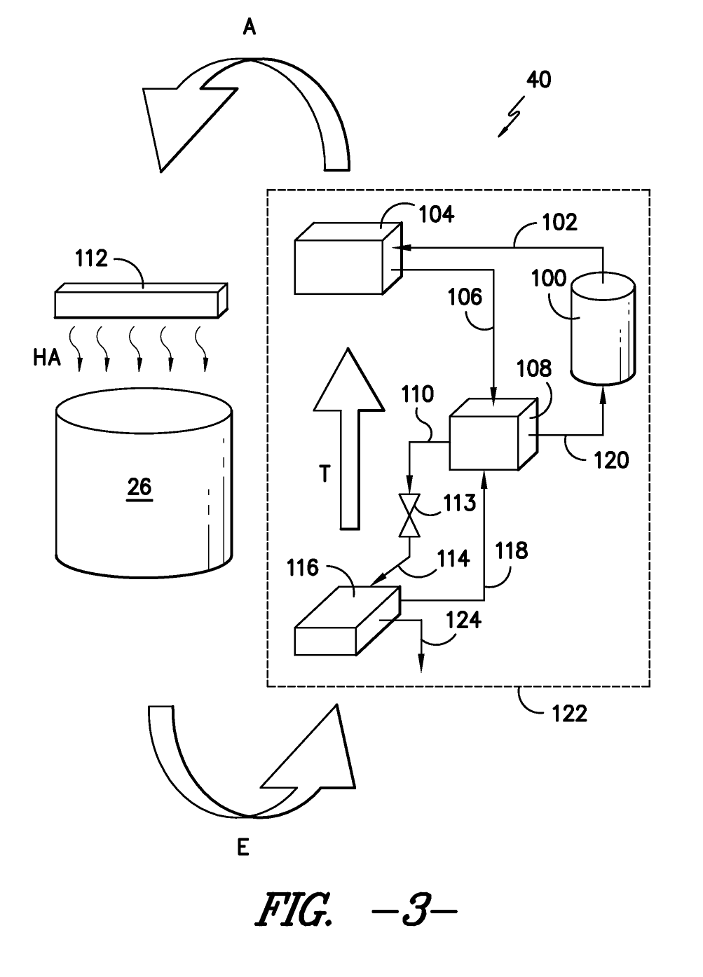

FIG. 3 is a schematic representation of an exemplary embodiment of a heating system 40 as may be used with clothes dryer 10. Heating system 40 includes a refrigerant based heat pump system 122. In operation, warm air with a low or negligible amount of moisture is provided heat pump system 122 as shown by arrows. This air can be fed to another heater 112 that is used to further elevate the temperature of the air from system 122. Heater 112 can be e.g., an electric coil/strip type of heater

As shown by arrows HA, warm air from the optional heater 112 is fed into clothes dryer 10 where it contacts articles in drum 26. As drum 26 rotates with cabinet 12, the articles are tumbled to facilitate exposure to the warm air from heater 112. Moisture from the article is absorbed into this relatively dry air and, as such, is removed from the articles in drum 26 as part of the drying process. This moisture laden air is then returned to the refrigerant based heating system 122 for further treatment as shown by arrow E.

More specifically, the moisture laden air (arrow E) is first caused to flow across an evaporator 116, where the temperature of the air is reduced through heat exchange with refrigerant that is vaporized within e.g., coils or tubing of evaporator 116. This vaporization process absorbs both the sensible and the latent heat from the moisture laden air—thereby reducing its temperatures. As a result, moisture in the air is condensed and is drained out using line 124.

The air from evaporator 116 is now drier and much cooler than when it left drum 26 of dryer 10. As shown by arrow T, air from evaporator 116 is now cause to flow through gas cooler 104 (e.g., across coils or tubing in gas cooler 104). As used herein, it should be understood that the term “gas cooler” also includes one or more condensers and other heat exchangers for cooling and/or condensing the refrigerant. The refrigerant in gas cooler 104 is in a gaseous state at a relatively high temperature compared to the air from evaporator 116. As a result, heat energy is transferred to the air—thereby elevating its temperature and providing warm air A for resupply to heater 112 as shown by arrow A. Because the same air is recycled through drum 26 and heating system 40, dryer 10 can have a much greater efficiency than traditional clothes dryers where warm, moisture laden air is exhausted to the environment.

Refrigerant based heating system 122 includes a compressor 100 that pressurizes refrigerant—i.e. increases the pressure of the refrigerant supplied by suction line 120. Compressor 100 is designed to pressurize a gas phase refrigerant. Accordingly, in order to avoid damage, it is important that refrigerant in suction line 120 is all supplied in a gas phase.

The pressurization of the refrigerant with compressor 100 increases the temperature of the refrigerant. Accordingly, by line 102, the compressed refrigerant is fed to a gas cooler 104. As relatively cooler air from the evaporator (arrow T) is passed over the gas cooler 104, the refrigerant is cooled and its temperature is lowered as heat is transferred to the air for supply to heater 112 as shown by arrow A. However, although cooled by gas cooler 104, the refrigerant in gas cooler outlet line 106 is still relatively warm. As a result, gas cooler outlet line 106 feeds the refrigerant to a heat exchanger 108 for additional cooling as will be further described.

Upon exiting heat exchanger 108, the refrigerant is fed by line 110 to an expansion device 113. Although only one expansion device 113 is shown, such is by way of example only—it being understood that multiple such devices may be used. Expansion device 113 lowers the pressure of the refrigerant and controls the amount of refrigerant that is allowed to enter the evaporator 116 by line 114. Importantly, the flow of liquid refrigerant into evaporator 116 is limited by expansion device 113 in order to keep the pressure low and allow expansion of the refrigerant back into the gas phase in the evaporator 116.

The evaporation of the refrigerant in the evaporator 116 converts the refrigerant from its liquid-dominated phase to a gas phase, which is fed by suction line 118 to heat exchanger 108. More particularly, the relatively cool, gaseous refrigerant in suction line 118 is used to absorb heat from the relatively hot, liquid refrigerant coming from gas cooler 104 by gas cooler outlet line 106.

Accordingly, heat exchanger 108 can dramatically improve the efficiency of heating system 40 and, therefore clothes dryer 10. The heat exchanger 108 improves the thermodynamic efficiency of heating system 40 by cooling liquid refrigerant before it enters the expansion device 113 thereby lowering the enthalpy of the refrigerant entering the evaporator 116. The cooling effect of the refrigerant in suction line 118 might not otherwise be fully utilized if not used to cool the warmer liquid refrigerant coming from gas cooler 104. Furthermore, the heating effect of the refrigerant in the gas cooler outlet line 106 increases the degree of superheat in the suction line 120. This increases the heat capacity of the evaporator. Heat exchanger 108 can also increase the performance of system 40 by reducing the transient period before reaching quasi-steady state conditions for operation of system 40. Additionally, the cooling of liquid refrigerant by exchanger 108 can also help prevent the unwanted formation of gas at the inlet to expansion device 113 by flashing of the liquid.

Furthermore, by providing heat to the refrigerant in suction line 118 from the higher temperature liquid refrigerant in the gas cooler outlet line 116, heat exchanger 108 operates to ensure that any residual liquid that may remain in suction line 118 is fully vaporized before reaching the compressor 100. As stated previously, the presence of liquid in suction line 120 that is fed to compressor 100 is adverse to proper performance and can be even permanently damage compressor 100.

Heat exchanger 108 can also operate as an accumulator of liquid refrigerant supplied by suction line 118. To the extent any liquid remains in the refrigerant after passing through evaporator 116, heat exchanger 108 can also assist in holding or accumulating such liquid until the heat transfer in exchanger 108 converts such liquid into the gaseous refrigerant needed for compressor 100.

The exemplary embodiment of a clothes dryer appliance 10 of the present invention was described above with heater 112. It should be noted that heater 112 is not required. More specifically, in certain exemplary embodiments, the present invention may be operated solely using heat provided by the gas cooler 104.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A laundry dryer, comprising:
a drum for receipt of a load of articles for drying;
a heater for raising the temperature of air supplied to said drum; and, a refrigerant based heating system comprising:
a compressor for pressurizing a refrigerant;
a gas cooler for cooling refrigerant from said compressor and heating air provided to said drum or said heater;
an evaporator for vaporizing refrigerant and cooling and dehumidifying air from said drum; and,
a heat exchanger for transferring heat between refrigerant flowing from said gas cooler and refrigerant flowing from said evaporator.

2. A laundry dryer as in claim 1, further comprising:
at least one fan for causing air to flow through said heater, said drum, said evaporator, and said gas cooler.

3. A laundry dryer as in claim 1, further comprising:
a suction line connecting said evaporator and said gas cooler, said suction line providing for a flow of refrigerant through said heat exchanger.

4. A laundry dryer as in claim 3, wherein said heat exchanger is configured to vaporize all refrigerant in said suction line before the refrigerant is fed to said compressor.

5. A laundry dryer as in claim 1, further comprising:
a gas cooler outlet line providing for a flow of refrigerant from said gas cooler and through said heat exchanger.

6. A laundry dryer as in claim 1, further comprising an expansion device for receiving refrigerant from said gas cooler.

7. A laundry dryer as in claim 1, further comprising:
a gas cooler outlet line providing for a flow of refrigerant from said gas cooler and through said heat exchanger; and,
an expansion device for reducing the pressure of refrigerant received from said heat exchanger.

8. A laundry dryer as in claim 7, wherein said heat exchanger is configured to sub-cool the refrigerant before the refrigerant is supplied to said expansion device.

9. A laundry dryer as in claim 7, wherein said heat exchanger further comprises an accumulator for liquid refrigerant.

10. A laundry dryer, comprising:
a drum for the receipt of articles for drying;
a fan for circulating air for drying articles in said drum; and,
a system for the treatment of the air circulated by said fan, said system comprising:
a compressor for pressurizing a refrigerant;
a gas cooler for exchanging heat between the refrigerant and the air circulated by said fan so as to increase the temperature of air fed to said drum;
an evaporator for exchanging heat between the refrigerant and the air circulated by said fan so as decrease the temperature and moisture content of air fed from said drum; and,
a heat exchanger for cooling refrigerant from said gas cooler with refrigerant from said evaporator.

11. A laundry dryer as in claim 10, further comprising a heater for raising the temperature of air fed from said gas cooler and to said drum.

12. A laundry dryer as in claim 10, further comprising:
a suction line connecting said evaporator and said compressor, said suction line providing for a flow of refrigerant through said heat exchanger.

13. A laundry dryer as in claim 12, wherein said heat exchanger is configured to vaporize all refrigerant in said suction line before the refrigerant is fed to said compressor.

14. A laundry dryer as in claim 10, further comprising:
a gas cooler outlet line providing for a flow of refrigerant from said gas cooler and through said heat exchanger.

15. A laundry dryer as in claim 10, further comprising an expansion device for receiving refrigerant from said gas cooler.

16. A laundry dryer as in claim 10, further comprising:
a gas cooler outlet line providing for a flow of refrigerant from said gas cooler and through said heat exchanger; and,
an expansion device for reducing the pressure of refrigerant received from said heat exchanger.

17. A laundry dryer as in claim 16, wherein said heat exchanger is configured to sub-cool the refrigerant before the refrigerant is supplied to said expansion device.

18. A laundry dryer as in claim 16, wherein said heat exchanger further comprises an accumulator for liquid refrigerant.
